(19) United States
(12) Patent Application Publication
(10) Pub. No.: US 2002/0060711 A1
(43) Pub. Date: May 23, 2002

(54) Ink jet printer provided with maintenance system

(76) Inventors: Wataru Ito, Tokyo (JP); Humio Maeno, Saitama (JP); Tetsuya Yamamoto, Tokyo (JP); Takeo Komiyama, Saitama (JP)

Correspondence Address: FINNEGAN, HENDERSON, FARABOW, GARRETT &, DUNNER LLP, 1300 I STREET, NW, WASHINGTON, DC, 20005, US

(21) Appl. No.: 09/486,372

(22) PCT Filed: Sep. 2, 1998
(86) PCT No.: PCT/JP98/03936

(30) Foreign Application Priority Data
May 28, 1998 (JP) PCT/JP98102368

(51) Int. Cl. B41J 2/165

(52) U.S. Cl. 347/28

(57) ABSTRACT

An ink-jet printer comprises a machine frame (14); a printing head (16) provided reciprocatingly movable in a predetermined direction in the machine frame, the printing head including a plurality of nozzles (28) for ejecting ink droplets and at least one nozzle surface (30) on which the nozzles open; ink-supply means (18) for supplying ink to the printing head; material-feeding means (20) for feeding a material to be printed (M) into a printing area (P) opposed to the printing head in the machine frame; and maintenance means (22) provided with a plurality of functional stations distributively arranged at opposite end regions of a reciprocation range of the printing head in the machine frame. The functional stations include a sealing station (58) for substantially sealing and covering the nozzles opening on the nozzle surface of the printing head during an inoperative state of the printer so as to prevent ink in the nozzles from drying, a discharging station (60) for making ink, having an increased viscosity during the inoperative state of the printer, discharge from the nozzles, and a cleaning station (62) for sucking to remove ink, having an increased viscosity during the inoperative state of the printer, and for washing and wiping the nozzle surface.

### TECHNICAL FIELD

The present invention relates to a non-impact type printer, and particularly to an ink-jet printer using a quick-dry-type pigment ink.

### BACKGROUND ART

As non-impact type printers are less noisy during printing of characters or images and can perform color printing, they have been used in various fields. For example, an ink-jet printer wherein ink-droplets are ejected from a number of micro-nozzles provided in a printing head onto a material to be printed to carry out a printing operation, and particularly an on-demand type ink-jet printer wherein piezoelectric elements are used in the printing head, has recently prevailed as an output device for a personal computer or a word processor, because it can print on a plain paper and the size of the printer body thereof is easily reduced.

On the other hand, impact-type printers have relatively simple structures, which makes the maintenance thereof easy, and have advantages in running cost due to, e.g., an inexpensive ink ribbon, and are thus widely used as printers for industrial use, such as a printer for printing on a bankbook or a slip in a bank (hereinafter referred to as a bankbook printer). Nowadays, however, even in the field of bankbook printers, requirements have been risen for, e.g., noise reduction, downsizing and an improvement in operation time (i.e., a time period required for user's operation between the introducing of a bankbook into the printer and the retrieval thereof after it is printed). Therefore, it has become difficult to satisfy these requirements with an impact-type printer.

One problem to be solved when an ink-jet printer is used as an industrial printer concerns the maintenance thereof.

Generally, in the ink-jet printers, the drying-up of ink in the nozzles of a printing head, fluctuation of an ink meniscus therein, excessive ink attaching onto the peripheral region of nozzle openings in a nozzle surface of the printing head, and so on, may become the main factors for disturbing the control of ejection of ink droplets and reducing printing quality. Accordingly, most conventional ink-jet printers have been provided with maintenance devices for excluding these factors reducing printing quality, which may be caused during the inoperative state of the printer, so as to recover the printing quality before starting the subsequent printing operation.

As this type of maintenance device, the following devices have been known: a sealing device for hermetically sealing a number of nozzle openings provided on a nozzle surface of a printing head, while the printer does not operate, to prevent ink from drying near the nozzle openings; a washing device for washing the nozzle surface after completing the printing operation and/or before starting the subsequent printing operation; a wiping device for wiping the nozzle surface in a similar way; a suction device for sucking and removing ink provided with increased viscosity (or partially drying up) in the nozzles while the printer does not operate, before starting the subsequent printing operation; and so forth.

In the conventional ink-jet printer, a dyestuff ink containing a dyestuff used as a colorant is generally used. However, in some application fields of the ink-jet printer (e.g., in a bankbook printer), it may be required for the ink printed on a material to be printed to dry in a shorter time. On this occasion, a pigment ink of quick-dry type containing a pigment used as a colorant is used.

When such a quick-dry type pigment ink is used as an ink for the ink-jet printer, it is desired that the function of the above-mentioned maintenance devices for recovering the printing quality is further enhanced. Especially, in the industrial printers, there are extremely various conditions of nozzles, which may result in the deterioration of printing quality at the beginning of the next printing operation, because of the various time intervals of the inoperative states of the printers. Consequently, it is desired to convert the maintenance devices into a multi-functional system, so as to select and perform an optimum sequence for recovering the printing quality in view of cost and time, in correspondence with the nozzle conditions. However, the conventional ink-jet printer has incorporated therein a minimum number indispensably selected from the above-mentioned maintenance devices mainly due to the dimensional limitation of a machine body, and the ink-jet printer incorporating therein a maintenance system having a multifunctional printing-quality recovering function has not yet been realized.

Further, since a printer for industrial use may be installed and used in various environments, there is a necessity for supposing that the printer might be used in an environment including ambient air with high dust content. Particularly, in the case of the ink-jet printer, it is important to prevent dust from attaching to a nozzle region, and therefore, it is also necessary to prevent external dust being entering into and depositing on any area of the above-mentioned various maintenance devices, the area being expected to access the nozzle region during the maintenance operation.

### DISCLOSURE OF THE INVENTION

An object of the present invention is to provide an ink-jet printer with a maintenance system having a multifunctional printing-quality recovering function.

Another object of the present invention is to provide an ink-jet printer, using a quick-dry type pigment ink, which can be used as an industrial printer and, particularly, as a bankbook printer.

A further object of the present invention is to provide a maintenance system, for use in an ink-jet printer, capable of preventing external dust entering into and deposited on any area of the maintenance system, the area being expected to access to the nozzle region during the maintenance operation.

A yet further object of the present invention is to provide an ink-jet printer incorporating therein such a maintenance system, which can be installed and used in various environments.

To accomplish the above objects, the present invention provides an ink-jet printer comprising a machine frame; a printing head provided reciprocatingly movable in a predetermined direction in the machine frame, the printing head including a plurality of nozzles for ejecting ink droplets and at least one nozzle surface on which the nozzles open; ink-supply means for supplying ink to the printing head; material-feeding means for feeding a material to be printed into a printing area opposed to the printing head in the machine frame; and maintenance means provided with a plurality of functional stations distributively arranged at opposite end regions of a reciprocation range of the printing head in the machine frame, the functional stations including a sealing station for substantially sealing and covering the nozzles opening on the nozzle surface of the printing head during an inoperative state of the printer so as to prevent ink in the nozzles from drying, a discharging station for making ink, provided with an increased viscosity during the inoperative state of the printer, discharge from the nozzles, and a cleaning station for sucking to remove ink, provided with an increased viscosity during the inoperative state of the printer, and for washing and wiping the nozzle surface.

In this ink-jet printer, the sealing station and the discharging station may be arranged at one end region of the reciprocation range of the printing head, and the cleaning station may be arranged at another end region of the reciprocation range of the printing head.

Also, the sealing station may comprise a sealing device disposed in the machine frame to be shiftable in a direction toward and away from the printing head located opposite to the sealing station, and the sealing device may include at least one cap for covering the at least one nozzle surface of the printing head when the at least one cap approaches the printing head, and at least one air conduit acting to communicate a space defined between the nozzle surface and the cap with an ambient atmosphere and to substantially maintain the space at a saturated vapor pressure.

It is preferred that the air conduit of the sealing device extends at one end thereof into the cap to open toward a bottom surface of the cap opposed to the nozzle surface of the printing head, and extends at another end thereof in a meandering manner to open into the ambient atmosphere.

It is advantageous that the sealing device includes an openable/closable cover member for substantially sealing an opening of the cap when the sealing device does not operate.

It is preferred that the sealing device further includes a body for elastically supporting the cap.

In this arrangement, it is advantageous that a spherical supporting surface is provided in association with at least one of the cap and the body, and that the cap is supported on the body through the supporting surface.

The cleaning station may comprise a suction device disposed in the machine frame to be shiftable in a direction toward and away from the printing head located opposite to the cleaning station, a washing device coupled to the suction device, and a wiping device disposed in the machine frame to be shiftable in a direction toward and away from the printing head located opposite to the cleaning station.

The suction device may include at least one cap for covering the at least one nozzle surface of the printing head when the at least one cap approaches the printing head, a pump connected with a space defined between the nozzle surface and the cap to generate a negative pressure in the space when the pump operates, and a waste-liquid storage section connected with the pump to store ink sucked and removed from the nozzles.

It is preferred that the suction device further includes a body for elastically supporting the cap.

In this arrangement, it is advantageous that a spherical supporting surface is provided in association with at least one of the cap and the body, and that the cap is supported on the body through the supporting surface.

It is preferred that the washing device includes a washing-liquid storage section connected to the space defined between the nozzle surface of the printing head and the cap of the suction device, and a valve member disposed between the space and the washing-liquid storage section, and that the valve member acts, to interrupt communication between the space and the washing-liquid storage section during an operation of the suction device for sucking to remove ink from the nozzles, and to open communication between the space and the washing-liquid storage section after the operation for sucking has been completed.

In this arrangement, the pump of the suction device may operate during an opening state of the valve member of the washing device, so as to make a washing liquid discharge from the washing-liquid storage section into the space, and to collect the washing liquid into the waste-liquid storage section.

It is desired that at least one washing-liquid conduit independent from the ink-supply means is provided between the cap of the suction device and the washing-liquid storage section of the washing device.

A displacement of the suction device and the wiping device relative to the printing head as well as an opening/closing operation of the valve member of the washing device may be performed by a common drive source.

Preferably, the suction device includes an openable/closable cover member for substantially covering an opening of the cap when the suction device does not operate.

The wiping device may include an endless tape-like wiping member capable of coming into contact with the at least one nozzle surface of the printing head when the wiping device approaches the printing head, and a feeding mechanism for feeding the wiping member every time a wiping operation has been completed to renew an operative section to be in contact with the nozzle surface.

A displacement of the wiping device relative to the printing head as well as a feeding operation of the feeding mechanism may be performed by a common drive source.

The ink-supply means may comprise three separate ink-storage sections and three separate ink-supply conduits connecting the ink-storage sections to the printing head, and the printing head may comprise three separate subheads connected to the ink-supply conduits, each of the subheads being provided with the nozzles and the nozzle surface.

In this arrangement, the ink-jet printer may be used as a color printer.

Alternatively, the ink-jet printer may be used as a bankbook printer.

The present invention also provides a nozzle sealing device disposed in a reciprocation range of a printing head of an ink-jet printer, comprising a body shiftable in a direction toward and away from the printing head located opposite thereto; at least one cap provided in the body to cover a nozzle surface of the printing head when the cap approaches the printing head; and at least one air conduit acting to communicate a space defined between the cap and the nozzle surface of the printing head with an ambient atmosphere and to substantially maintain the space at a saturated vapor pressure.

It is preferred that the air conduit extends at one end thereof into the cap to open toward a bottom surface of the cap opposed to the nozzle surface of the printing head, and extends at another end thereof in a meandering manner to open into the ambient atmosphere.

Preferably, the nozzle sealing device further comprises an openable/closable cover member for substantially covering an opening of the cap when the nozzle sealing device does not operate.

The present invention further provides a nozzle washing device disposed in a reciprocation range of a printing head of an ink-jet printer, comprising a body shiftable in a direction toward and away from the printing head located opposite thereto; at least one cap provided in the body to cover a nozzle surface of the printing head when the cap approaches the printing head; a washing-liquid storage section connected to a space defined between the cap and the nozzle surface of the printing head; a valve member disposed between the space and the washing-liquid storage section; a pump connected to the space to generate a negative pressure in the space when the pump operates; and a waste-liquid storage section connected to the pump to store a washing liquid sucked and removed from the space; wherein the pump operates, while the valve member interrupts communication between the space and the washing-liquid storage section, to suck and remove ink from the nozzles of the printing head, and wherein the pump operates, while the valve member opens communication between the space and the washing-liquid storage section, to make a washing liquid discharge from the washing-liquid storage section into the space and to collect the washing liquid into the waste-liquid storage section.

At least one washing-liquid conduit independent from an ink-supply system of the ink-jet printer may be provided between the cap and the washing-liquid storage section.

Preferably, the nozzle washing device further comprises an openable/closable cover member for substantially covering an opening of the cap when the nozzle washing device does not operate.

### BRIEF DESCRIPTION OF THE DRAWINGS

The above and other objects, features and advantages of the present invention will be described with reference to the preferred embodiments shown in the attached drawings, wherein:

FIG. 1 is a schematic perspective view showing in a partially perspective manner the main components of an ink-jet printer incorporating therein a maintenance system according to one embodiment of the present invention;

FIG. 2 is a schematic view of the maintenance system incorporated in the ink-jet printer shown in FIG. 1;

FIG. 3 is a schematic perspective view of a printing head of the ink-jet printer shown in FIG. 1;

FIG. 4 is a schematic perspective view of a sealing device of the ink-jet printer shown in FIG. 1;

FIG. 5 is a schematic sectional view of the sealing device shown in FIG. 4;

FIG. 6 is a schematic perspective view of a support plate of the sealing device shown in FIG. 4;

FIG. 7 is a diagram illustrating the timing of operation of the sealing device shown in FIG. 4;

FIG. 8 is a schematic perspective view of a suction device and a washing device of the ink-jet printer shown in FIG. 1;

FIG. 9 is a view similar to FIG. 8, wherein a part of a body of the suction device, a cover member and a second cam are omitted;

FIG. 10 is a partially sectional schematic view of the suction device and the washing device shown in FIG. 8;

FIGS. 11A and 11B are schematic sectional views respectively showing the upward and downward motions of the suction device shown in FIG. 8;

FIG. 12 is a schematic sectional view of a modification of the sealing device shown in FIG. 4;

FIG. 13 is a schematic perspective view of a wiping device of the ink-jet printer shown in FIG. 1; and

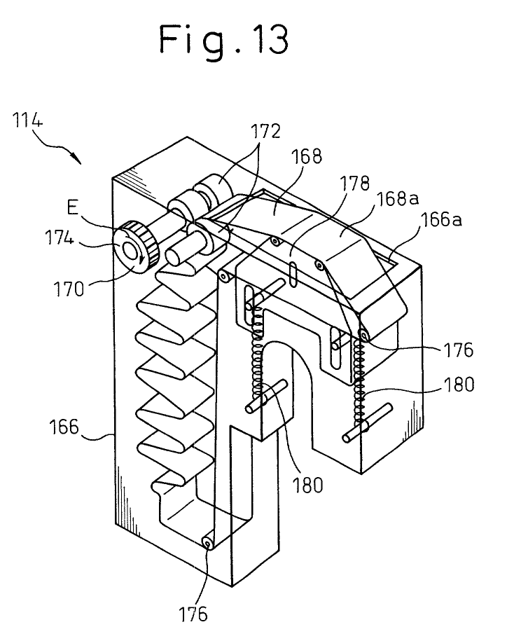

FIG. 14 is a diagram illustrating the timings of operation of the suction device, the washing device and the wiping device of the ink-jet printer shown in FIG. 1.

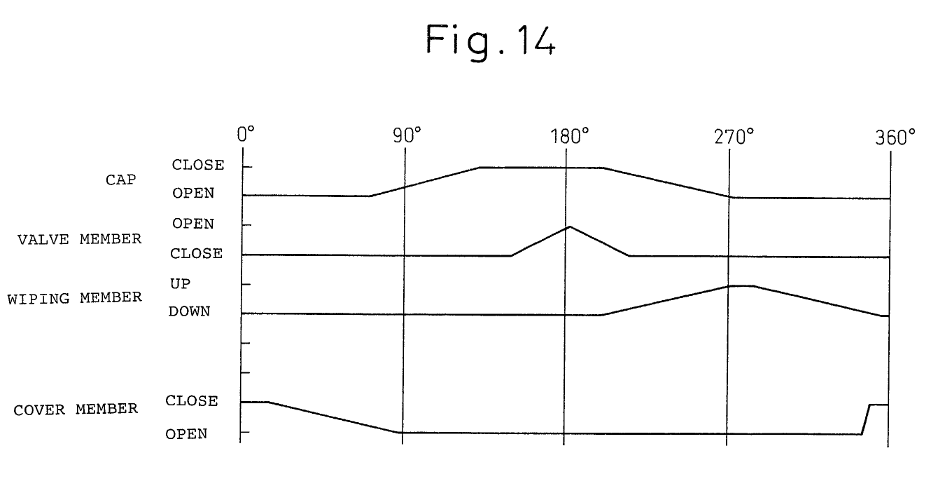

### BEST MODES FOR CARRYING OUT THE INVENTION

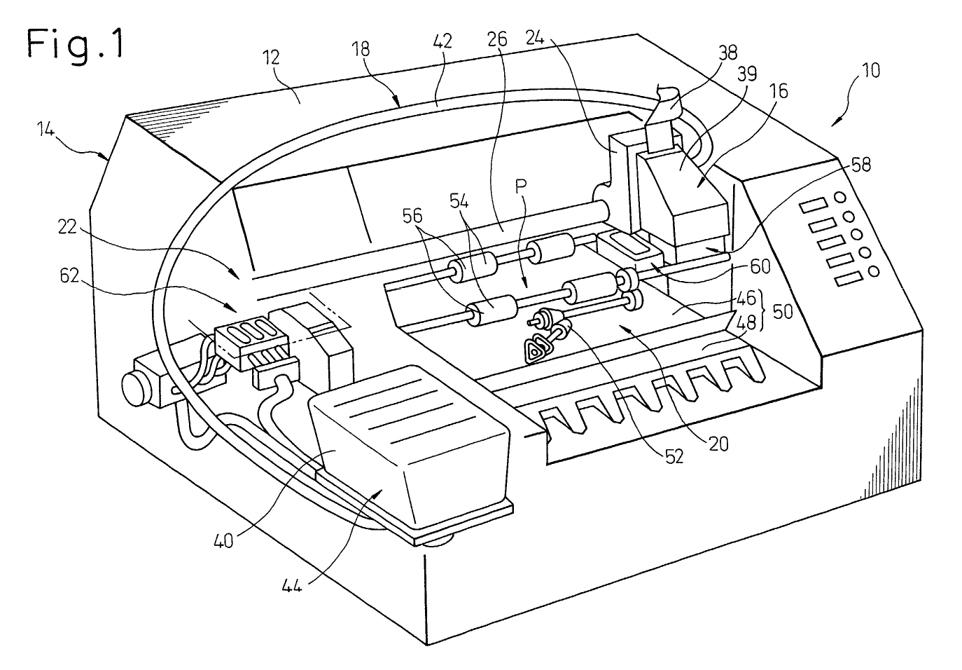

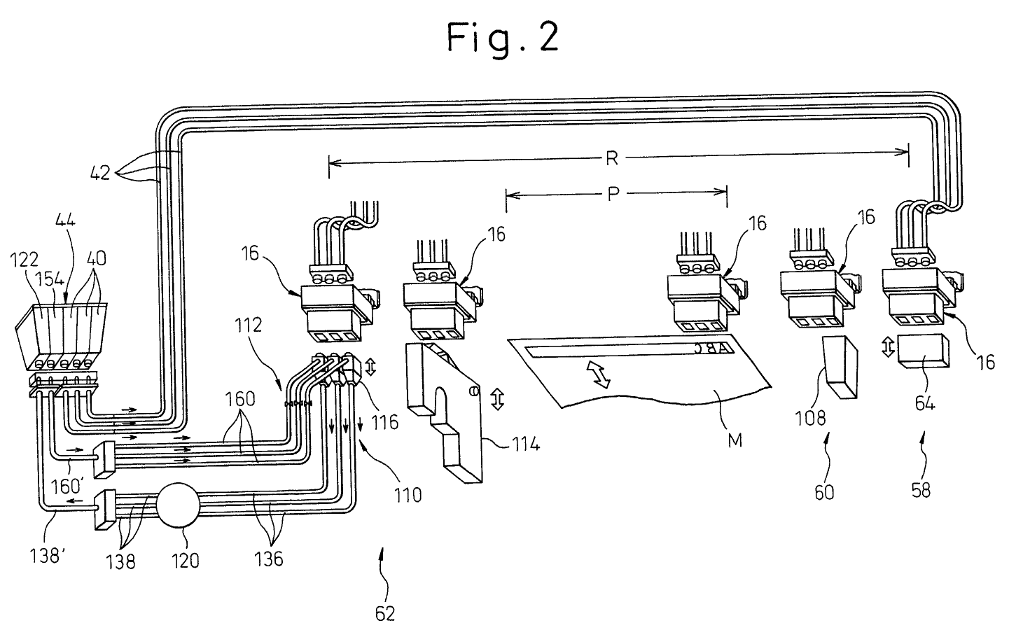

With reference to the drawings, FIG. 1 is a schematic perspective view showing, in a partially perspective manner, the main components of an ink-jet printer 10 incorporating therein a maintenance system according to one embodiment of the present invention, and FIG. 2 is a schematic illustration of the maintenance system of the ink-jet printer 10.

The ink-jet printer 10 is provided with a machine frame 14 including an openable/closable housing 12 and a machine body not shown, a printing head assembly 16 (hereinafter referred to as merely a printing head 16) provided reciprocatingly movable in a predetermined direction (usually in a horizontal direction relative to a reference plane on which the printer is installed) in the machine frame 14, ink-supply means 18 for supplying ink to the printing head 16, a material-feeding means 20 for feeding a material to be printed M into a printing area P opposed to the printing head 16 in the machine frame 14, and maintenance means 22 including a plurality of functional stations arranged in a distributed manner in opposite end regions of the reciprocation range R of the printing head 16 in the machine frame 14.

The printing head 16 is fixed to a carriage 24 which, in turn, is carried on a guide bar 26, extending in the horizontal direction in the machine frame 14, so as to be slidingly movable in the axial direction of the bar. During the printing operation, the printing head 16 is reciprocated in the horizontal direction along the guide bar 26 by means of a driving mechanism not shown.

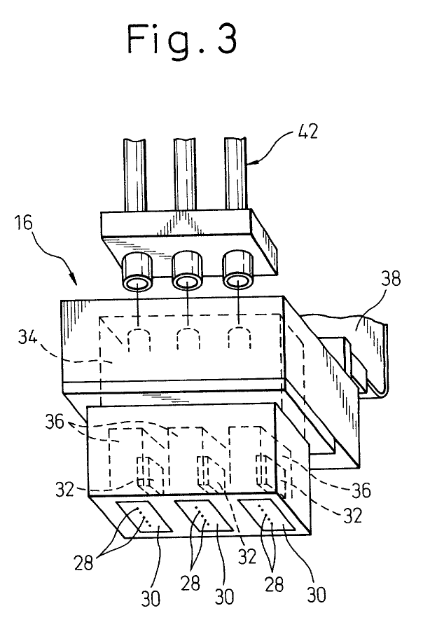

As schematically shown in FIG. 3, the printing head 16 is provided with a plurality of nozzles 28 for ejecting ink-droplets, a nozzle surface 30 onto which the nozzles 28 open, and an actuator 32 composed of piezoelectric elements for making the nozzles 28 eject ink-droplets. In the illustrated embodiment, the printing head 16 includes separate three subheads 36, each of which is provided with the plural nozzles 28, the nozzle surface 30 and the actuator 32. Between three subheads 36 of the printing head 16 and the ink-supply means 18, a pressure-fluctuation damping unit or a damper 34 is provided for suppressing the pressure fluctuation of ink in an ink-supply path and for stabilizing a meniscus of ink entering the respective nozzles 28. A flexible circuit board 38 for applying a driving voltage onto the actuator 32 is shown in FIGS. 1 and 3. Also, as shown in FIG. 1, the printing head 16 is usually covered with an openable/closable cover 39 attached to the carriage 24.

As shown in FIGS. 1 and 2, the ink-supply means 18 is provided with an ink-storage section 40 arranged at a position apart from the printing head 16 in the machine frame 14, and an ink-supply conduit 42 connecting the printing head 16 with the ink-storage section 40, to supply an ink, such as a quick-dry type pigment ink, to the printing head 16 during the printing operation. In the illustrated embodiment, the ink-supply conduit 42 is formed of a sufficiently flexible tube so as not to interfere with the reciprocating motion of the printing head 16.

Also, in the illustrated embodiment, the ink-supply means 18 includes three separate ink-storage sections 40 and three separate ink-supply conduits 42 connecting the respective ink-storage sections 40 to the respective subheads 36 of the printing head 16 (FIG. 2). Accordingly, the ink-jet printer 10 is usable as a color printer. Further, in the illustrated embodiment, three ink-storage sections 40 are formed within a cartridge type ink tank 44 detachably mounted at a predetermined position on the machine frame 14.

The material-feeding means 20 disposed beneath the reciprocation range R of the printing head 16 includes a material-nipping section 50 having an upper fixed plate 46 and a lower movable plate 48 and holding the material to be printed M, such as a printing paper or a bankbook, inserted between the plates 46, 48, a correcting mechanism 52 arranged above the fixed plate 46 for correcting the feeding direction of the material to be printed M held in the material-holding section 50, and a feeding mechanism 54 disposed above the fixed plate at a position behind the correcting mechanism 52 in the material-feeding direction, for introducing the material to be printed M, held in the material-holding section 50, into the printing area P and discharging the same from the printing area P.

The printing area P is defined between two pairs of feed rollers 56 constituting the feeding mechanism 54. The printing head 16 reciprocates along the guide bar 26 above the printing area P, and scans the material to be printed M introduced into the printing area P while forming characters or images on the material to be printed M by ejecting ink droplets from the nozzles 28.

The plural functional stations constituting the maintenance means 22 include a sealing station 58 for substantially sealing arid covering the plural nozzles 28 opening on the nozzle surface 30 of the printing head 16 when the printer does not operate, so as to prevent the ink in the nozzles 28 from drying, a discharging station 60 for making the nozzles 28 of the printing head 12 discharge the ink of which the viscosity is increased in the nozzles 28 during the inoperative state of the printer, and a cleaning station 62 for sucking and removing the ink of which the viscosity is increased in the nozzles 28 during the inoperative state of the printer and for washing and wiping the nozzle surface 30. In the illustrated embodiment, the sealing station 58 and the discharging station 60 are disposed in one end region (a right end region in the drawing) of the reciprocation range R of the printing head, and the cleaning station 62 is disposed in another end region (a left end region in the drawing) of the reciprocation range R of the printing head.

Such a distributive arrangement of the various functional stations facilitates the effective utilization of an idle space in the machine frame 14 of the ink-jet printer 10. That is, in a general ink-jet printer, since the printing operation is carried out on the material to be printed while the printing head reciprocates in the predetermined direction, the reciprocation range of the printing head is determined to be wider than a dimension of the material-feeding device disposed opposite to the printing head. As a result, an idle space is inevitably formed around the material-feeding device. Therefore, in the ink-jet printer 10, the above-mentioned functional stations for establishing a multifunctional maintenance system are distributively arranged in the idle space, so as to effectively prevent the machine size from being enlarged. Further, the ink-jet printer 10 having such a multifunctional maintenance system can safely use the quick-dry type pigment ink, and thus can be suitably applied to printers for industrial use, e.g., to a bankbook printer. Constructions of the respective functional stations will be described below.

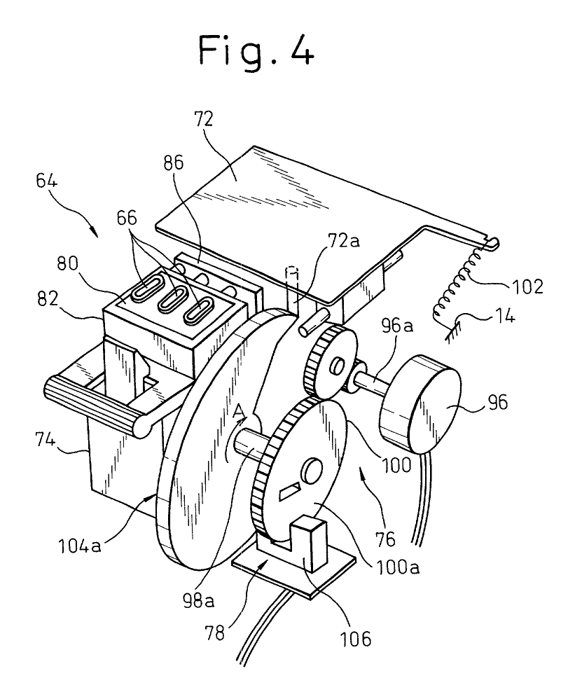

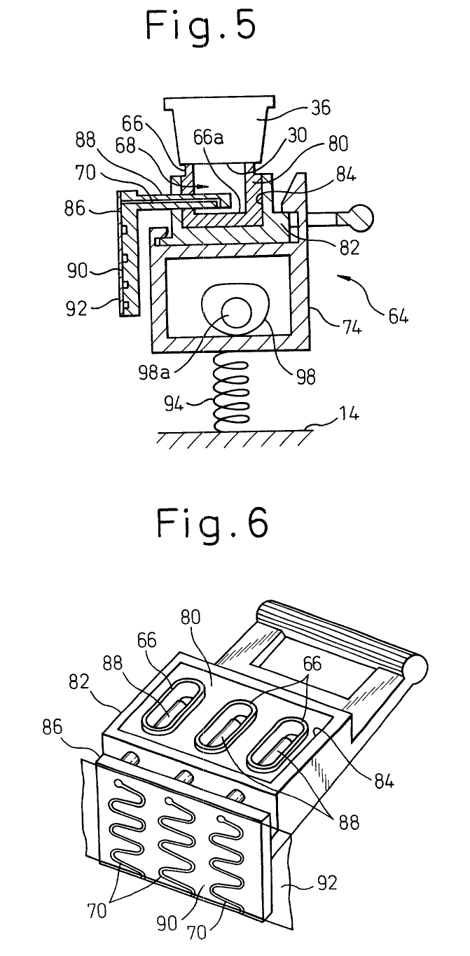

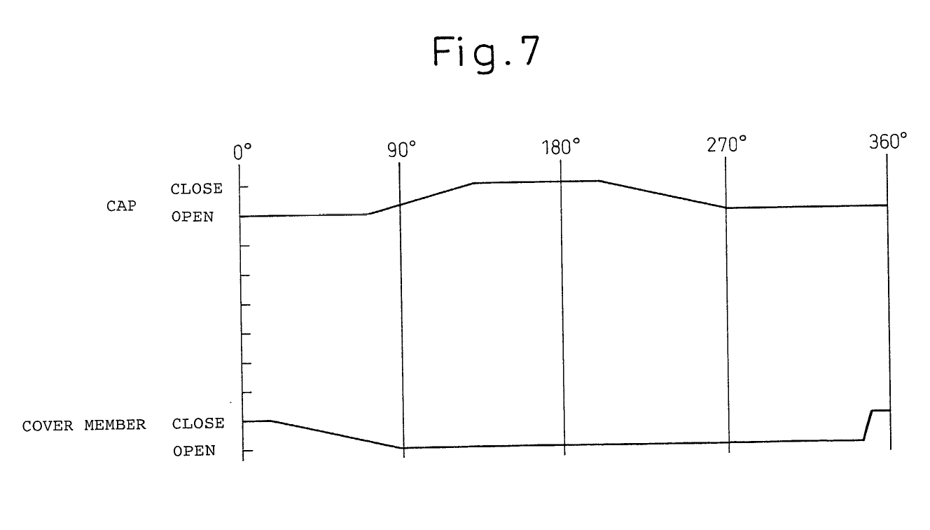

The sealing station 58 is provided with a sealing device 64 arranged at a position where it can be opposed to the printing head 16 located at one end (a right end in the drawing) of the reciprocation range R, the sealing device 64 being mounted in the machine frame 14 shiftably in a direction toward and away from the printing head 16. As shown in FIGS. 4 to 6, the sealing device 64 has three caps 66 for individually covering the nozzle surfaces 30 of the respective subheads 36 when approaching the printing head 16, and three air conduits 70 for communicating spaces 68 defined between respective nozzle surfaces 30 and respective caps 66 with an ambient atmosphere so as to maintain the spaces 68 at a saturated vapor pressure.

Preferably, the sealing device 64 is provided with an openable/closable cover member 72 for substantially covering the openings of three caps 66 during an inoperative state. The cover member 72 acts to prevent external dust from entering into and being deposited on the interior of the respective caps 66 of the sealing device, the caps being expected to approach the area of nozzles 28 of the printing head 16 during the sealing operation. As a result., the ink-jet printer 10 can be installed and used in various environments including a dusty environment wherein the ambient atmosphere has a high dust-content.

The sealing device 64 is further provided with a body 74 for supporting three caps 66, a drive mechanism 76 for shifting the body 74 in the direction toward and away from the printing head 16 and for driving the cover member 72 to open and close, and a detecting mechanism 78 for detecting an operational position of the drive mechanism 76.

Three caps 66 are made of elastic materials, such as rubber, capable of being respectively in close contact with the nozzle surfaces 30, and are integrally coupled to each other to form a cap member 80. The cap member 80 is fixedly received in a recess 84 of a support plate 82 secured to the body 74. The support plate 82 is structured to be detachably attached to the body 74 by a snap action, so that the cap member 80 can be readily cleaned or replaced.

Three air conduits 70 are formed in a conduit member 86 fixedly connected to the support plate 82. The conduit member 86 is provided with three tubular sections 88 extending into the interior of the respective caps 66 while penetrating a wall defining the recess 84 of the support plate 82 and a wall of the cap member 80, and a plate-like section 90 integrally coupled to the tubular sections 88 and disposed outside the support plate 82. Each air conduit 70 extends in each tubular section 88, and opens at one end thereof toward a bottom face 66a of each cap 66 opposed to the nozzle surface 30. Further, each air conduit 70 is formed as a groove meandering in the plate-like section 90, and opens at the other end thereof to an ambient atmosphere. A film 92 is attached to the plate-like section 90 to cover the meandering portions of the respective air conduits 70.

If the space 68 between the cap 66 and the nozzle surface 30 is tightly sealed when the body 74 approaches to the printing head 16 and the respective caps 66 are brought into close contact with the nozzle surfaces 30 of the respective subheads 36, the inner pressure of the space 68 resultantly rises. Such an inner pressure rise tends to create bubbles in ink held inside the nozzles 28 during the nozzle sealing state of the sealing device 64. The air conduits 70 act to communicate the spaces 68 with the ambient atmosphere, and thus can prevent the inner pressure rise and bubble creation from happening. The air conduits 70 extend in a meandering manner in the plate-like section 90 so as to increase the entire length thereof, and thus can maintain the interior of the spaces 68 substantially at a saturated vapor pressure for a long time. Thereby, the sealing device 64 can effectively prevent the ink held inside the nozzles 28 from drying. Also, since the air conduit 70 opens toward the bottom face 66a of the cap 66 in the space 68, a risk of blocking the opening of the air conduit therewith can be avoided, even though the ink leaks out of the nozzles 28 and drops into the opening during the nozzle sealing state.

The body 74 of the sealing device 64 is elastically connected to the machine frame 14 through biasing means such as a spring 94, and is biased in a direction toward the printing head 16 by the spring 94. The drive mechanism 76 includes a drive source 96 such as an electric motor, a first cam 98 disposed in the interior of the body 74 while abutting a cam surface onto a wall surface of the body 74, and a gear train 100 for transmitting a torque from an output shaft 96a of the drive source 96 to a shaft 98a of the first cam 98. The first cam 98 is driven by the drive source 96 to rotate in a direction shown by an arrow A, and shifts the body 74 in the direction away from the printing head 16 against the biasing force of the spring 94 depending on a rotational angle of the first cam. In the illustrated embodiment, during a single rotation of the first cam 98, the body 74 is subjected to one cycle of an up-and-down reciprocating motion between a full-close position where each cap 66 covers the nozzle surface 30 of each subhead 36 and a full-open position where each cap 66 releases the nozzle surface 30. It is preferred that guide means, not illustrated, is provided for enabling the body 74 to stably shift up-and-down in a predetermined direction.

The cover member 72 is elastically connected to the machine frame 14 through biasing means such as a spring 102, is biased toward a direction for substantially covering the openings of the respective caps 66, and is driven by the drive mechanism 76 to selectively cover and open the openings of the respective caps 66 in association with the up-and-down reciprocating motion of the body 74. For this purpose, the drive mechanism 76 further includes a second cam 104 mounted to the shaft 98a of the first cam 98. The second cam 104 has an outer peripheral edge 104a which is abutted to a pin 72a provided on the cover member 72 within a predetermined range of a rotational angle. Accordingly, the second cam 104 is driven by the drive source 96 to rotate together with the first cam 98, and the peripheral edge 104a pushes the pin 72a of the cover member 72 in accordance with the rotation angle of the second cam, so as to move the cover member 72 in a direction for opening the openings of the respective caps 66 against the biasing force of the spring 102. It is preferred that cover-member guide means, not illustrated, is provided for enabling the cover member 72 to move stably in a predetermined direction.

The detecting mechanism 78 is structured by a gear 100a fixed to the shaft 98a of the first cam 98 and a sensor 106 for detecting a rotational home position of the gear 100a. The detecting mechanism 78 defines a home position of the shaft 98a of the first cam 98 of the drive mechanism 76 and detects a single rotation of the shaft 98a from the home position thereof.

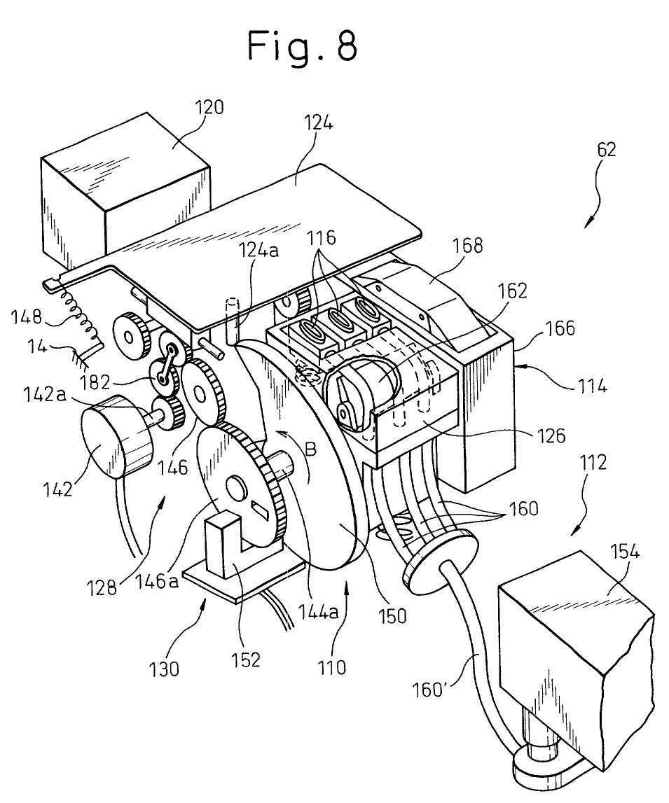

FIG. 7 illustrates a timing chart of the up-and-down motion of the body 74 and the open-and-close motion of the cover member 72, both due to the drive mechanism 76. A horizontal axis thereof represents a rotational angle of the shaft 98a of the first cam 98 from the home position. The home position of the shaft 98a is defined at a condition, as illustrated, where the body 74 or the caps 66 are in the fully-open position farthest from the nozzle surfaces 30 and the cover member 72 is in a fully-closed position for covering the openings of the caps 66.

When the shaft 98a is driven by the drive source 96 to rotate from the home position, first the cover member 72 begins to open the openings of the respective caps 66. Then, just before the cover member 72 reaches the full-open position, the respective caps 66 begin to move in a direction toward the respective nozzle surfaces 30. After the cover member 72 has reached the full-open position, the respective caps 66 are abutted to the respective nozzle surfaces 30 (at the full-close position) to cover the nozzle surfaces 30. In this state, the printing head 16 is waiting for the next printing operation, whereby ink in the nozzles 28 is prevented from being dried during this state. Upon starting the next printing operation, the shaft 98a is driven again by the drive source 96 to rotate, and the body 74 or the respective caps 66 moves away from the respective nozzle surfaces 30. At a predetermined timing after the respective caps 66 have reached the full-open position but before the shaft 98a has rotated in a single rotation from the home position, the cover member 72 instantly returns to the full-close position due to the biasing force of the spring 102.

In the case of using a quick-dry type pigment ink in the ink-jet printer 10, the ink may still increase in viscosity or partially dry in the respective nozzles 28 of the printing head 16 in the waiting state at the sealing station 58 during the inoperative state of the printer, even though the function for preventing the ink from drying is properly exhibited in the sealing device 64, due to the installation environment and use frequency of the printer. The discharging station 60 is provided for recovering the printing quality by positively discharging such ink with increased viscosity or which is partially dried, from the nozzles 28 immediately before the waiting printing head 16 starts the next printing operation. For this purpose, the discharging station 60 is provided with an ink receiving vessel 108 fixedly disposed adjacent to the sealing device 64 of the sealing station 58 in one end (the right end in the drawing) region of the reciprocation range R of the printing head 16. The ink receiving vessel 108 is detachably mounted in the machine frame 14 for the purpose of ink disposal.

The discharging station 60 is provided for removing in a discharging manner the ink provided with increased viscosity during the inoperative state of the printer in the respective nozzles 28 of the printing head 16, and therefore, it is necessary to operate the actuators 32 of the respective subheads 36 of the printing head 16. On the other hand, the cleaning station 62 is structured from a suction device 110 for positively sucking, from the outside of the nozzles 28, to remove the ink provided with increased viscosity during the inoperative state of the printer, a washing device 112 for washing the nozzle surfaces 30 on which the ink leaks around the opening of the respective nozzles 28, and a wiping device 114 for wiping the ink or a washing liquid held on the nozzle surfaces 30. Accordingly, in the cleaning station 62, it is not necessary to operate the actuators 32 of the respective subheads 36 of the printing head 16.

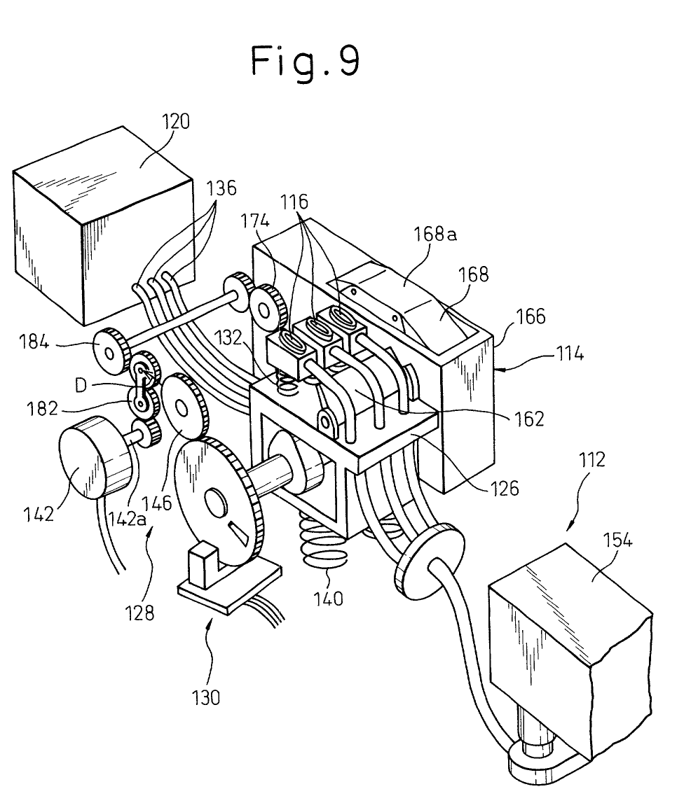

The suction device 110 of the cleaning station 62 is arranged at a position where it can be opposed to the printing head 16 located at another end (a left end in the drawing) of the reciprocation range R, and is mounted in the machine frame 14 shiftably in a direction toward and away from the printing head 16. As shown in FIGS. 8 to 10, the suction device 110 has three caps 116 for individually covering the nozzle surfaces 30 of the respective subheads 36 when approaching the printing head 16, a pump 120 connected to the respective spaces 118 defined between the respective nozzle surfaces 30 and the respective caps 116 and operated to create a negative pressure inside the spaces 118, and a waste-liquid storage section 122 for storing the ink sucked and removed from the respective nozzles 28.

Preferably, the suction device 110 is provided with an openable/closable cover member 124 for substantially covering the openings of three caps 66 during an inoperative state. The cover member 72 acts to prevent external dust from entering into and being deposited on the interior of the respective caps 66 of the sucking device, the caps being expected to approach the area of nozzles 28 of the printing head 16 during the sealing operation. As a result, the ink-jet printer 10 can be installed and used in various environments including a dusty environment wherein the ambient atmosphere has a high dust-content.

The suction device 110 is further provided with a body 126 for supporting three caps 116, a drive mechanism 112 for shifting the body 126 in the direction toward and away from the printing head 16 and for driving the cover member 124 to open and close, and a detecting mechanism 130 for detecting an operational position of the drive mechanism 12E.

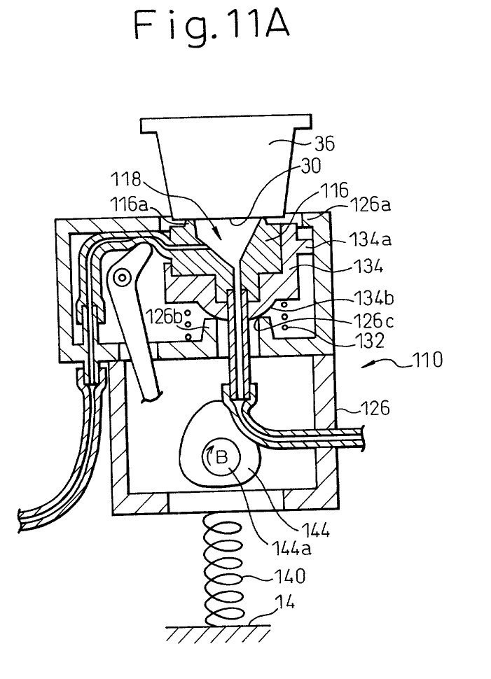

Three caps 66 are made of elastic materials, such as rubber, capable of being respectively in close contact with the nozzle surfaces 30, and are fixedly supported on cap holders 134 separately and elastically joined to the body 126 through biasing means such as springs 132. Each spring 132 urges the cap 116, through the cap holder 134, in the direction toward the nozzle surface 30. Each cap holder 134 has a projection 134a protruding laterally from the outer circumferential surface thereof. Each projection 134a is engaged with an opening edge 126a of the body 126 at a position where a peripheral lip 116a of the opening of the cap 116 projects above a top surface of the body 126, whereby each cap holder 134 is held on the body 125 against the biasing force of the spring 132 (FIG. 10).

Each cap holder 134 further includes a support surface 134b bulging out in a spherical shape from the bottom face thereof. A tube 135 having a bore communicated with the space 118 of the cap 116 is attached to each cap holder 134 while penetrating through the support surface 134b. Three receiving sections 126b, each having a hollow tubular shape, capable of bearing the respective support surfaces 134b are provided in the body 126 at positions opposed to the bottom surfaces of three cap holders 134. A bore of each receiving section 126b accommodates, in a non-contact manner, the tube 135 projecting from the support surface 134b of the cap holder 134. Each receiving section 126b is further provided with an opening edge 126c having a generally circular shape, which can slidingly contact with the support surface 134b of the cap holder 134. Consequently, each of three cap holders 134 can shift under the independent biasing function of the spring 132 between an uppermost position at which the projection 134a is engaged with the opening edge 126a of the body 126 and a lowermost position at which the support surface 134b comes into contact with the opening edge 126c of the receiving section 126b.

The pump 120 is formed as a triple pump which is connected in a fluidic communicative manner with three caps 116 through three separate conduit members 136, and is connected in a fluidic communicative manner with the waste-liquid storage section 122 through three separate conduit members 138. Accordingly, the pump 120 operates, when the body 126 approaches to the printing head 16 and the respective caps 116 are brought into close contact with the nozzle surfaces 30 of the respective subheads 36, to generate a negative pressure in the respective spaces 118 defined between the respective nozzle surfaces 30 and the respective caps 116. Thereby, the pump 120 sucks to remove a predetermined amount of ink from the respective nozzles 28 and feeds the removed ink to the waste-liquid storage section 122. In this regard, three conduit members 138 connecting the pump 120 to the waste-liquid storage section 122 may be collected to a single conduit member 138 as shown in FIG. 2.

The body 126 is elastically connected to the machine frame 14 through biasing means such as a spring 140, and is biased in a direction toward the printing head 16 by the spring 140. The drive mechanism 128 includes a drive source 142 such as an electric motor, a first cam 144 disposed in the interior of the body 126 while abutting a cam surface onto a wall surface of the body 126, and a gear train 146 for transmitting a torque from an output shaft 142a of the drive source 142 to a shaft 144a of the first cam 144. The first cam 144 is driven by the drive source 142 to rotate in a direction shown by an arrow B, and shifts the body 126 in a direction away from the printing head 16 against the biasing force of the spring 140 depending on a rotational angle of the first cam. In the illustrated embodiment, during a single rotation of the first cam 144, the body 126 is subjected to one cycle of up-and-down reciprocating motion between a full-close position where each cap 116 covers the nozzle surface 30 of each subhead 36 and a full-open position where each cap 116 releases the nozzle surface 30. It is preferred that guide means, not illustrated, is provided for enabling the body 126 to stably shift up-and-down in a predetermined direction.

When the body 126 is in the full-close position, each cap 116 comes into close contact with the nozzle surface 30 of each subhead 36 under the biasing force of the spring 140, and each spring 140 can compensate for a relative error in a positional relationship, including a distance, between the body 126 and each nozzle surface 30. Accordingly, the total biasing force of the springs 132 is selected to be smaller than the biasing force of the spring 140.

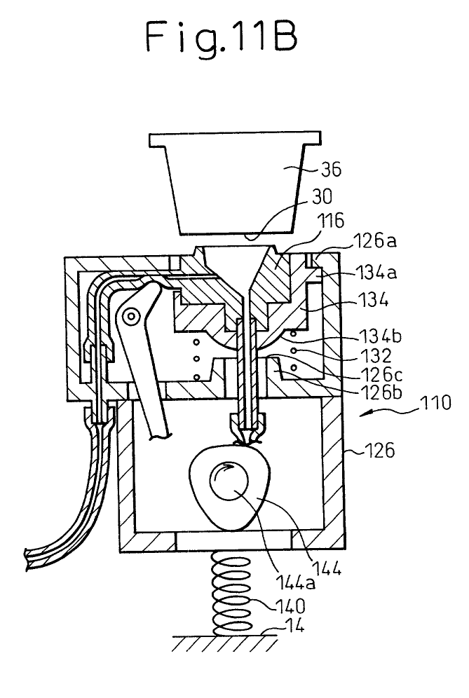

More specifically, when the first cam 144 slightly rotates from a position shown in FIG. 10 and the body 126 thereby reaches the full-close position, the peripheral lip 116a of the opening of each cap 116 comes into close contact with the nozzle surface 30 of each subhead 36, and the cap holder 134 fixedly supporting each cap 116 compresses the spring 132 to be located, usually, at the above-described lowermost position in the body 126, as shown in FIG. 11A. In this position, each cap holder 134 is abutted at the support surface 134b thereof to the opening edge 126c of the receiving section 126b of the body 126, so that the biasing force of the spring 140 is transmitted to each cap 116 through the body 126 and each cap holder 134 and, thereby, each cap 116 comes firmly into close contact with each nozzle surface 30. Thereafter, when the first cam 144 further rotates and the body 126 thereby reaches the full-open position, the peripheral lip 116a of the opening of each cap 116 is disengaged from the nozzle surface 30 of each subhead 36, and the projection 134a of each cap holder 134 is engaged with the opening edge 126a of the body 126 to locate the cap holder 134 at the above-described uppermost position in the body 126 under the biasing force of the spring 132.

If the body 126 of the suction device 110 is obliquely disposed in relation to the respective subheads 36 of the printing head 16, there is a risk that each cap 116 cannot correctly come into close contact with each nozzle surface 30 even when the body 126 is in the full-close position. In this regard, according to the above arrangement, when the body 126 approaches the printing head 16 and each cap 116 initially comes into contact with each nozzle surface 30 (FIG. 10), the cap 116 is individually and elastically supported by the spring 132 on the body 126. Therefore, even if the respective subheads 36 and the body 126 are obliquely disposed relative to each other, the position of each cap holder 134 is automatically corrected in the body 126, whereby each cap 116 can properly come into close contact with each nozzle surface 30.

Further, when the body 126 reaches the full-close position and each cap holder 134 is located at the lowermost position, the spherical support surface 134b is slidably abutted to the circular opening edge 126c of the receiving section 126b, so that each cap holder 134 can freely slide on the receiving section 126b. Therefore, even if the respective subheads 36 and the body 126 are obliquely disposed relative to each other, the position of each cap holder 134 is also automatically corrected, so that each cap 116 can correctly come into close contact with each nozzle surface 30 under the biasing force of the spring 140.

Shapes of the support surface 134b of the cap holder 134 and the opening edge 126c of the receiving section 126b are not limited to the above-mentioned shapes, provided that the shapes facilitate the relative sliding motion therebetween. For instance, it may be possible to combine the spherical support surface 134b with an opening edge 126c extending in a rectangular shape. Also, it is possible to form the opening edge 126c as a spherical surface. Alternatively, a conical or pyramidal support surface 134b can be combined with a spherical opening edge 126c. However, the above-described combination of the spherical support surface 134b with the circular opening edge 126c has an advantage from the viewpoint of a low sliding resistance and simple molding.

The cover member 124 of the suction device 110 is elastically connected to the machine frame 14 through biasing means such as a spring 148. The cover member 124 is biased by the spring 148 in a direction for substantially covering the openings of the respective caps 116, and is driven by the drive mechanism 128 to selectively cover and open the openings of the respective caps 116 in association with the up-and-down motion of the body 124. For this purpose, the drive mechanism 128 further includes a second cam 150 mounted to the shaft 144a of the first cam 144. The second cam 150 has an outer peripheral edge 150a which is abutted to a pin 124a provided on the cover member 124 within a predetermined range of a rotational angle. Accordingly, the second cam 150 is driven by the drive source 142 to rotate together with the first cam 144, and the peripheral edge 150a pushes the pin 124a of the cover member 124 in accordance with the rotation angle of the second cam, so as to move the cover member 124 in a direction for opening the openings of the respective caps 116 against the biasing force of the spring 148.

The detecting mechanism 130 is structured by a gear 146a fixed to the shaft 144a of the first cam 144 and a sensor 152 for detecting a rotational home position of the gear 146a. The detecting mechanism 130 defines a home position of the shaft 144a of the first cam 144 of the drive mechanism 128 and detects a single rotation of the shaft 144a from the home position thereof.

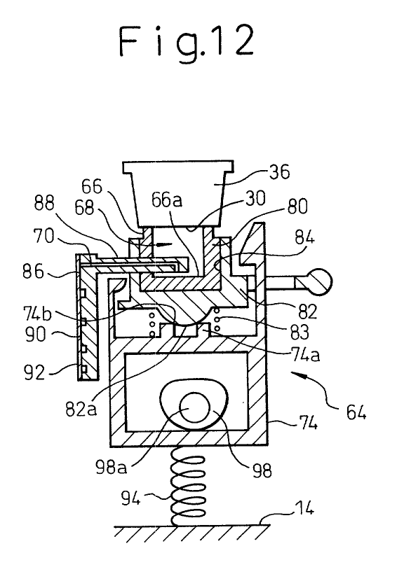

The above-described floating structure of the respective caps 116 of the suction device 110 can also be applied to the respective caps 66 of the sealing device 64. In this case, a spring 83 is disposed between the body 74 of the sealing device 64 and the support plate 82, as shown in FIG. 12, so that the support plate 82 supporting the cap member 80 is floatable above the body 74 under the biasing force of the spring 83. A support surface 82a spherically bulging outward is formed on the bottom face of the support plate 82, and a hollow tubular receiving section 74a capable of bearing the support surface 82a is provided correspondingly on the body 74. The receiving section 74a has a generally circular opening edge 74b capable of coming into sliding contact with the support surface 82a of the support plate 82. It will be understood that, according to this arrangement, even if the respective subheads 36 of the printing head 16 and the body 74 of the sealing device 64 are obliquely disposed relative to each other, the position of the support plate 82 is automatically corrected, so that each cap 66 can accurately come into close contact with each nozzle surface 30, in the same manner as described with reference to the suction device 110.

The washing device 112 of the cleaning station 62 includes a washing-liquid storage section 154 connected to the respective spaces 118 defined between the nozzle surfaces 30 of the respective subheads 36 of the printing head 16 and the respective caps 116 of the suction device 110, and a valve member 156 disposed between the spaces 118 and the washing-liquid storage section 154. As shown in FIG. 11, each cap 116 of the suction device 110 is provided with a conduit section 158 defining a washing-liquid conduit 158a communicating with the space 118. The washing-liquid storage section 154 is connected in a fluidic communicative manner to the conduit sections 158 of the caps 116 by three separate piping elements 160 through a wall of the body 126 of the suction device 110. In this regard, three piping elements 160 may be collected to a single piping element 160′ as shown in FIGS. 2 and 8.

The valve member 156 is structured from a lever 162 pivotably mounted in the body 126 of the suction device 110. The lever 162 is biased by biasing means such as a torsion spring to an initial position where one end 162a thereof is abutted to the conduit sections 158 of the respective caps 116. At the initial position, the end 162a of the lever 162 compresses the conduit sections 158 of the respective caps 116 under the biasing force of the biasing means to close the washing-liquid conduits 158a. When the lever 162 is rotated in a direction shown by an arrow C against the biasing force of the biasing means, the end 162a of the lever 162 is disengaged from the conduit sections 158 of the respective caps 116 so as to open the washing-liquid conduits 158a.

This pivot motion of the lever 162 is caused by the drive mechanism 128 of the suction device 110 in association with the up-and-down motion of the body 124 of the suction device 110. That is, a third cam 164 is mounted to the shaft 144a of the first cam 144 of the suction device 110 at a position adjacent to the first cam 144. The third cam 164 is driven by the drive source 142 of the drive mechanism 128 to rotate in the direction of the arrow B and pushes, at the cam surface thereof, the other end 162b of the lever 162 in accordance with the rotation angle of the third cam. The lever 162 is thereby rotated against the biasing force of the biasing means in a direction shown by an arrow C, so as to disengage the end 162a of the lever 162 from the conduit sections 158 of the respective caps 116.

The washing device 112 operates as follows. While the suction device 110 is sucking to remove ink from the respective nozzles 28 by the operation of the pump 120, the lever 162 is located in the initial position and the end 162a thereof acts as a valve member 156 to compress the conduit sections 158 of the respective caps 116 under the biasing force of the biasing means so as to close the washing-liquid conduits 158a. Accordingly, even if a negative pressure is generated in the spaces 118, washing liquid cannot enter into the spaces 118. After the suction and removal operation has completed, the lever 162 is rotated by the pushing action of the third cam 164 while the body 126 of the suction device 110 is maintained at the full-close position to keep the respective caps 116 being in close contact with the nozzle surfaces 30 of the respective subheads 36. Thereby, the end 162a of the lever 162 is disengaged from the conduit sections 158 of the respective caps 116, so as to open the washing-liquid conduits 158a.

Then, the washing liquid is discharged from the washing-liquid storage section 154 through the conduit members 160 and the conduit sections 158 into the spaces 118 by the operation of the pump 120, so that the nozzle surfaces 30 of the respective subheads 36 are washed with the washing liquid. In this case, the pump 120 may continuously operate subsequent to the suction and removal operation, or may be temporarily interrupted after the suction and removal operation has completed. The washing liquid after it is used is sucked through the conduit members 136 by the pump 120 and is fed to the waste-liquid storage section 122 through the conduit members 138.

In the illustrated embodiment, the waste-liquid storage section 122 and the washing-liquid storage section 154 are formed together with three ink-storage sections 40 in the cartridge-type ink tank 44 detachably mounted to the machine frame 14 at a predetermined position (FIG. 2). Also, the conduit members 160 of the washing device 112 and the conduit sections 158 of the respective caps 116 of the suction device 110 form a washing-liquid conduit which is independent of the respective ink-supply conduits 42 of the ink-supply means 18.

As will be understood from the above description, the suction device 110 and the washing device 112 have a functional and structural relationship to each other. Therefore, these devices may be assumed to be, in combination, a washing device having a sucking function or a suction device having a washing function.

The wiping device 114 of the cleaning station 62 is disposed adjacent to the suction device 110, and is mounted in the machine frame 14 to be shiftable in a direction toward and away from the printing head 16 located at the other end (left end in the drawing) of the reciprocation range R. In the illustrated embodiment, the wiping device 114 is provided with a casing 166 fixedly joined to the body 126 of the suction device 110, and moves upward and downward in association with the up-and-down motion of the suction device 110.

As shown in FIG. 11, the wiping device 114 includes an endless tape-like wiping member 168 which can contact the nozzle surfaces 30 of the respective subheads 36 upon approaching the printing head 16, and a feeding mechanism 170 for feeding the wiping member 168 and renewing an operative surface section 168a thereof for contacting with the nozzle surfaces 30 every time the wiping operation is completed. The feeding mechanism 170 includes a pair of feeding rollers 172 for nipping the wiping member 168 therebetween and feeding it in a predetermined direction, and a gear 174 fixed to a shaft of one of the feeding rollers 172. The wiping device 114 further includes a set of tension rollers 176 for applying tension force to the operative surface section 168a of the wiping member 168, a movable carrier member 178 for slidably carrying a back surface of the operative surface section 168a of the wiping member 168, and a pair of springs 180 for biasing the movable carrier member 178 in a direction for projecting the operative surface section 168a of the wiping member 168 outward from a window 166a of the casing 166.

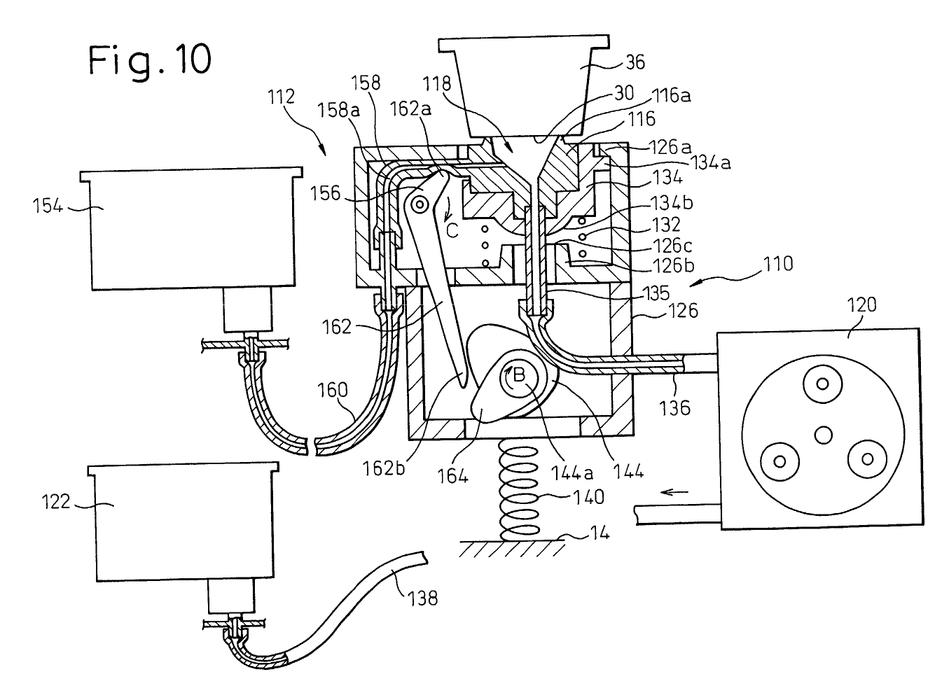

The feeding mechanism 170 of the wiping device 114 is selectively coupled to the drive source 142 of the suction device 110. More specifically, the drive mechanism 128 of the suction device 110 is provided at the midway of the gear train 146 with a differential gear 182 which can turn in accordance with the rotating direction of the output shaft 142a of the drive source 142. Accordingly, when the up-and-down motion of the suction device 110 and the wiping device 114 relative to the printing head 16 as well as the open-and-close motion of the valve member 156 of the washing device 112 are carried out by the common drive source 142, the differential gear 182 normally operates in the gear train 146 so as to transmit a torque from the output shaft 142a of the drive source 142 to the shaft 144a of the first cam 144. When the output shaft 142a of the drive source 142 is reversely rotated at a desired timing, the differential gear 182 turns in a direction shown by an arrow D in FIG. 9 to be disengaged from the gear train 146. Then, the differential gear 182 is meshed with a power-transmission gear assembly 184 having a pair of gears on a common shaft, whereby the torque of the drive source 142 is transmitted to the gear 174 of the feeding mechanism 170 of the wiping device 114 through the power-transmission gear assembly 184. Thus, in the delivery mechanism 170, the pair of feeding rollers 172 rotate in a direction shown by an arrow E in FIG. 11 to feed a predetermined length of the wiping member 168 so as to clean a contaminated operative surface section 168a.

In the illustrated embodiment, the cover member 124 of the suction device 110 is structured to also cover the wiping member 168 of the wiping device 114. Consequently, it is possible to prevent dust from entering into and depositing on at least the operative surface section 168a of the wiping member 168.

FIG. 12 shows a timing of the up-and-down motion of the body of the suction device 126, the open-and-close motion of the valve member 156 of the washing device 112, the up-and-down motion of the casing 166 of the wiping device 114 and the open-and-close motion of the cover member 124 of the suction device 110, all being caused by the drive mechanism 128 of the suction device 110. A horizontal axis represents a rotation angle of the shaft 144a of the first cam 144 of the drive mechanism 128 from the home position thereof.

As illustrated, the home position of the shaft 144a is defined in a condition where the body 126 of the suction device 110, or the respective caps 116, is located at the full-open position farthest from the respective nozzle surfaces 30 of the printing head 16, where the valve member 156 of the washing device 112 is located at the full-close position to close the washing liquid conduits 158a, where the casing 166 of the wiping device 114, or the wiping member 168, is located at the lowermost position farthest from the respective nozzle surfaces 30 of the printing head 16, and where the cover member 124 of the suction device 110 is located at the full-close position to close the opening of the respective caps 116.

When the shaft 144a is driven by the drive source 142 to rotate from the home position, the cover member 124 begins to open the openings of the respective caps 116. Immediately before the cover member 124 has reached the full-open position, the respective caps 116 begin to shift in the direction toward the respective nozzle surfaces 30, and after the cover member 124 has reached the full-open position, the respective caps 116 are abutted against the nozzle surfaces 30 (at the full-close position) to cover the nozzle surfaces 30. In this state, the pump 120 is actuated to suck and remove the ink in the nozzles 28. Subsequently, the shaft 144a is driven by the drive source 142 to rotate, whereby the valve member 156 moves to the full-open position to open the washing liquid conduits 158a. When the valve member 156 is located at the full-open position, the pump 120 operates to supply the washing liquid to the nozzle region so as to wash the respective nozzle surfaces 30, and to suck and remove the contaminated washing liquid after it is used.

After the washing process, the valve member 156 returns to the full-close position by the rotation of the shaft 144a, and subsequent thereto, the body 126 of the suction device 110, or the respective caps 116, moves in the direction away from the respective nozzle surfaces 30. On the other hand, generally simultaneously with the disengagement of the respective caps 116 from the respective nozzle surfaces 30, the wiping member 168 begins to approach the respective nozzle surfaces 30. After the respective caps 116 have reached the full-open position, the wiping member 168 arrives at the uppermost position to come into contact with the respective nozzle surfaces 30 and wipes the liquid held on the nozzle surfaces 30. Then, the wiping member 168 returns to the lowermost position by the rotation of the shaft 144a. Immediately before the shaft 144a makes single rotation from the home position and the wiping member 168 reaches to the lowermost position, the cover member 124 instantaneously returns back to the full-close position due to the biasing force of the spring 148.

### INDUSTRIAL APPLICABILITY

The present invention effectively prevents a machine size from enlarging by distributively arranging various functional stations for realizing a multifunctional maintenance system in an idle space within a machine frame. The ink-jet printer having such a multifunctional maintenance system can safely use a quick-dry type pigment ink, and therefore, can be suitably used as an industrial printer such as a bankbook printer. Further, when a cover member is provided in each of maintenance devices, for preventing the external dust from entering into and depositing on an area of each device accessible to a nozzle region during the maintenance operation, the ink-jet printer can be installed and used in various environments including a dusty environment where the ambient atmosphere has a high dust content.

1. An ink-jet printer comprising:
a machine frame;
a printing head provided reciprocatingly movable in a predetermined direction in said machine frame, said printing head including a plurality of nozzles for ejecting ink droplets and at least one nozzle surface on which said nozzles open;
ink-supply means for supplying ink to said printing head;
material-feeding means for feeding a material to be printed into a printing area opposed to said printing head in said machine frame; and
maintenance means provided with a plurality of functional stations distributively arranged at opposite end regions of a reciprocation range of said printing head in said machine frame, said functional stations including a sealing station for substantially sealing and covering said nozzles opening on said nozzle surface of said printing head during an inoperative state of the printer so as to prevent ink in said nozzles from drying, a discharging station for making ink, provided with an increased viscosity during the inoperative state of the printer, discharge from said nozzles, and a cleaning station for sucking to remove ink, provided with an increased viscosity during the inoperative state of the printer and for washing and wiping said nozzle surface.

2. An ink-jet printer as defined in claim 1, wherein said sealing station and said discharging station are arranged at one end region of said reciprocation range of said printing head, and said cleaning station is arranged at another end region of said reciprocation range of said printing head.

3. An ink-jet printer as defined in claim 1, wherein said sealing station comprises a sealing device disposed in said machine frame to be shiftable in a direction toward and away from said printing head located opposite to said sealing station, and wherein said sealing device includes at least one cap for covering said at least one nozzle surface of said printing head when said at least one cap approaches said printing head, and at least one air conduit acting to communicate a space defined between said nozzle surface and said cap with an ambient atmosphere and to substantially maintain said space at a saturated vapor pressure.

4. An ink-jet printer as defined in claim 3, wherein said air conduit of said sealing device extends at one end thereof into said cap to open toward a bottom surface of said cap opposed to said nozzle surface of said printing head, and extends at another end thereof in a meandering manner to open into the ambient atmosphere.

5. An ink-jet printer as defined in claim 3, wherein said sealing device includes an openable/closable cover member for substantially sealing an opening of said cap when said sealing device does not operate.

6. An ink-jet printer as defined in claim 3, wherein said sealing device further includes a body for elastically supporting said cap.

7. An ink-jet printer as defined in claim 6, wherein a spherical supporting surface is provided in association with at least one of said cap and said body, and wherein said cap is supported on said body through said supporting surface.

8. An ink-jet printer as defined in claim 1, wherein said cleaning station comprises a suction device disposed in said machine frame to be shiftable in a direction toward and away from said printing head located opposite to said cleaning station, a washing device coupled to said suction device, and a wiping device disposed in said machine frame to be shiftable in a direction toward and away from said printing head located opposite to said cleaning station.

9. An ink-jet printer as defined in claim 8, wherein said suction device includes at least one cap for covering said at least one nozzle surface of said printing head when said at least one cap approaches said printing head, a pump connected with a space defined between said nozzle surface and said cap to generate a negative pressure in said space when said pump operates, and a waste-liquid storage section connected with said pump to store ink sucked and removed from said nozzles.

10. An ink-jet printer as defined in claim 9, wherein said suction device further includes a body for elastically supporting said cap.

11. An ink-jet printer as defined in claim 10, wherein a spherical supporting surface is provided in association with at least one of said cap and said body, and wherein said cap is supported on said body through said supporting surface.

12. An ink-jet printer as defined in claim 9, wherein said washing device includes a washing-liquid storage section connected to said space defined between said nozzle surface of said printing head and said cap of said suction device, and a valve member disposed between said space and said washing-liquid storage section, and wherein said valve member acts to interrupt communication between said space and said washing-liquid storage section during an operation of said suction device for sucking to remove ink from said nozzles, and to open communication between said space and said washing-liquid storage section after said operation for sucking has been completed.

13. An ink-jet printer as defined in claim 12, wherein said pump of said suction device operates during an opening state of said valve member of said washing device, so as to make a washing liquid discharge from said washing-liquid storage section into said space, and to collect the washing liquid into said waste-liquid storage section.

14. An ink-jet printer as defined in claim 12, wherein at least one washing-liquid conduit independent from said ink-supply means is provided between said cap of said suction device and said washing-liquid storage section of said washing device.

15. An ink-jet printer as defined in claim 12, wherein a displacement of said suction device and said wiping device relative to said printing head as well as an opening/closing operation of said valve member of said washing device are performed by a common drive source.

16. An ink-jet printer as defined in claim 9, wherein said suction device includes an openable/closable cover member for substantially covering an opening of said cap when said suction device does not operate.

17. An ink-jet printer as defined in claim 8, wherein said wiping device includes an endless tape-like wiping member capable of coming into contact with said at least one nozzle surface of said printing head when said wiping device approaches said printing head, and a feeding mechanism for feeding said wiping member every time a wiping operation has been completed to renew an operative section to be in contact with said nozzle surface.

18. An ink-jet printer as defined in claim 17, wherein a displacement of said wiping device relative to said printing head as well as a feeding operation of said feeding mechanism are performed by a common drive source.

19. An ink-jet printer as defined in claim 1, wherein said ink-supply means comprises three separate ink-storage sections and three separate ink-supply conduits connecting said ink-storage sections to said printing head, and wherein said printing head comprises three separate subheads connected to said ink-supply conduits, each of the subheads being provided with said nozzles and said nozzle surface.

20. An ink-jet printer as defined in claim 19, which is used as a color printer.

21. An ink-jet printer as defined in claim 1, which is used as a bankbook printer.

22. A nozzle sealing device disposed in a reciprocation range of a printing head of an ink-jet printer, comprising:
a body shiftable in a direction toward and away from said printing head located opposite thereto;
at least one cap provided in said body to cover a nozzle surface of said printing head when said cap approaches said printing head; and
at least one air conduit acting to communicate a space defined between said cap and said nozzle surface of said printing head with an ambient atmosphere and to substantially maintain said space at a saturated vapor pressure.

23. A nozzle sealing device as defined in claim 22, wherein said air conduit extends at one end thereof into said cap to open toward a bottom surface of said cap opposed to said nozzle surface of said printing head, and extends at another end thereof in a meandering manner to open into the ambient atmosphere.

24. A nozzle sealing device as defined in claim 22, further comprising an openable/closable cover member for substantially covering an opening of said cap when said nozzle sealing device does not operate.

25. A nozzle washing device disposed in a reciprocation range of a printing head of an ink-jet printer, comprising:
a body shiftable in a direction toward and away from said printing head located opposite thereto;
at least one cap provided in said body to cover a nozzle surface of said printing head when said cap approaches said printing head;
a washing-liquid storage section connected to a space defined between said cap and said nozzle surface of said printing head;
a valve member disposed between said space and said washing-liquid storage section;
a pump connected to said space to generate a negative pressure in said space when said pump operates; and
a waste-liquid storage section connected to said pump to store a washing liquid sucked and removed from said space;
wherein said pump operates, while said valve member interrupts communication between said space and said washing-liquid storage section, to suck and remove ink from said nozzles of said printing head, and wherein said pump operates, while said valve member opens communication between said space and said washing-liquid storage section, to make a washing liquid discharge from said washing-liquid storage section into said space and to collect the washing liquid into said waste-liquid storage section.

26. A nozzle washing device as defined in claim 25, wherein at least one washing-liquid conduit independent from an ink-supply system of the ink-jet printer is provided between said cap and said washing-liquid storage section.

27. A nozzle washing device as defined in claim 25, further comprising an openable/closable cover member for substantially covering an opening of said cap when said nozzle washing device does not operate.
